(19) United States
(12) Patent Application Publication
(10) Pub. No.: US 2004/0056375 A1
(43) Pub. Date: Mar. 25, 2004

(54) Method and apparatus for making miniature tablets

(76) Inventor: Gary Bubb, Pittstown, NJ (US)

Correspondence Address: Diane Dunn McKay, Esq., Mathews, Collins, Shepherd & McKay, P.A., Suite 306, 100 Thanet Circle, Princeton, NJ, 08540, US

(21) Appl. No.: 10/624,777

(22) Filed: Jul. 21, 2003

Related U.S. Application Data
(60) Provisional application No. 60/397,128, filed on Jul. 19, 2002.

(51) Int. Cl. D04H 1/00; B29C 43/02

(52) U.S. Cl. 264/40.5; 264/109; 264/319; 424/464; 425/354

(57) ABSTRACT

The present invention relates to a method and system for forming a miniature tablet using a predetermined compression force in a rotary tablet press. The predetermined compression force can be in the range of about 50 to about 2,000 Newtons, preferably less than about 500 Newtons. In one embodiment, the predetermined compression force is applied using an adjustable ramp for moving a lower punch upwardly towards a downwardly moving upper punch wherein the miniature tablet is formed in a die receiving the lower punch and the upper punch. The height of the adjustable ramp is accurately controlled to precisely provide the predetermined compression force for forming the miniature tablet. It has also been found that breakage of punch stems formed on the lower punch can be reduced by providing a reinforced portion of the punch stem below the slender portion of the punch stem which enters a bore of the die wherein the miniature tablet is formed. The reinforced portion of the punch stem is received in a counterbore portion of the die. A fill cam is adjusted to raise the position of the lower punch in order to maintain the punch stem in the bore of the die and prevent any material used for forming the miniature tablets from entering the counterbore of the die during filling of the die. A pull down cam is similarly adjusted to maintain the punch stem of the lower punch within the bore of the die. The miniature tablet can be used in place of extruded beads or coated non-pareils to provide drug delivery from a capsule.

### CROSS REFERENCE TO RELATED APPLICATION

This application claims priority to U.S. Provisional Application No. 60/397,128, filed on Jul. 19, 2002, the disclosure of which is hereby incorporated by reference in its entirety.

### BACKGROUND OF THE INVENTION

1. Field of the Invention

The present invention relates to a method and apparatus for making miniature tablets in which a tablet press is used having a predetermined compression force to form miniature tablets having a size of less than about three millimeters (mm) and weighing less than about 10 mg each.

2. Description of the Prior Art

One conventional, commonly used drug delivery system comprises a capsule filled with drug coated or drug layered non-pareil beads or drug loaded beads. Extrusion processes are used for forming the drug loaded beads. This process has the disadvantage that the extrusion process is complicated and time sensitive. The extrusion process also produces beads that are non-uniform in weight and steps must be taken to ensure that the variation in size from bead to bead is less than 10% in order to meet USP guidelines (each bead being less than 120 mg). The variation in size from bead to bead results in variation in the amount of drug applied to or loaded in each bead. Accordingly, there is little consistency in the amount of drug provided by each bead.

Further, when the drug is applied to the outside of the non-pareil bead, as opposed to being part of the matrix itself, there is always a risk that some of the drug may be sheared off the non-pareils, such as during handling of the non-pareils between when the drug has been applied and when the non-pareils are subjected to coating prior to being filled into capsules, thereby resulting in inconsistency from bead to bead in drug content. The wet granulation extrusion process is extremely sensitive to the types of powders that are blended together, granulated and then extruded to form the drug containing beads. The use of hydrophilic polymers is problematic because these polymers produce a pasty extrudate which is impossible to spheronize into small 0.5 mm to 3 mm beads.

Tablet press machines are known for compacting materials into solid form by exerting force on at least one set of two opposing punches entering a plurality of dies containing the material to be compacted. U.S. Pat. No. 4,362,493 describes that a conventional rotary tablet-making machines comprise a rotary turntable which carries near its periphery an annular series of die cavities in which the dies are clamped. Above and below the die turntable are upper and lower punches carried for rotation with the turntable, there being one upper and one lower punch for each die cavity. The heads of the punches may be guided by raising and lowering camming surfaces to control their reciprocating movements into or out of the die cavities as the die turntable rotates through filing, weight adjusting, compression and ejection stations all spaced around the single turntable.

Conventional tablet press machines have been used to form pharmaceutical tablets and caplets. Typical tablet weights are in the range of 350 to 500 mg. Compression force is applied by a set of compression rollers that the upper and lower punches travel under. The rolls are designed to produce compression forces in the range of 50 kilo-Newtons (kN) to 100 kN in order to compress the material to form the size tablet shape.

Multi-tip tooling has been used to provide small forces per tip. The overall force provided is the sum of all the tips which may be 2.4 kN for 12 tips. Multi-tip tooling has the drawback of being very expensive and provides no tablet weight control mechanism.

### SUMMARY OF THE INVENTION

The present invention relates to a method and system for forming a miniature tablet using a predetermined compression force in a rotary tablet press. The predetermined compression force can be in the range of about 50 to about 2,000 Newtons, preferably less than about 500 Newtons. It has been found that the use of conventional tablet press designed to apply forces in the range of about 50 kilo-Newtons to 100 kilo-Newtons in a tablet press have the drawback of breakage of tooling used for making a miniature tablet. For example, the punch stems used in forming a miniature tablet have a diameter slightly smaller than the diameter of the miniature tablet which is less than about 3 mm. The slender punch stems are prone to breakage if used with conventional compression machines, thereby interrupting production of the miniature tablets while the tooling is replaced. In one embodiment, the predetermined compression force is applied using an adjustable ramp for moving a lower punch upwardly towards a downwardly moving upper punch wherein the miniature tablet is formed in a die receiving the lower punch and the upper punch. The height of the adjustable ramp is accurately controlled to precisely provide the predetermined compression force for forming the miniature tablet. Conventional main compression rolls are impractical to provide forces in the range of about 50 to about 2,000 kilo-Newtons because they are not capable of being controlled for this subtlety or repeatability and are not capable of measuring the small compression forces with any accuracy.

It has also been found that breakage of punch stems formed on the lower punch can be reduced by providing a reinforced portion of the punch stem below the slender portion of the punch stem which enters a bore of the die wherein the miniature tablet is formed. The reinforced portion of the punch stem is received in a counterbore portion of the die. A fill cam is adjusted to raise the position of the lower punch in order to maintain the punch stem in the bore of the die and prevent any material used for forming the miniature tablets from entering the counterbore of the die during filling of the die. A pull down cam is similarly adjusted to maintain the punch stem of the lower punch within the bore of the die. In an embodiment of the present invention, the paddle feeder speed is accurately controlled to reduce the speed by at least a factor of 6 from conventional feeder speeds in order to feed the small amount of tablet mixture used for forming a miniature tablet.

In an alternate embodiment, the diameter of the conventional punches is reduced and the die height is smaller to reduce the column effect of using a very slender punch stem. The reduction in diameter of the punches allows additional stations to be provided on a similar sized rotatable conventional turret.

The present invention also provides a device for measuring mechanical strength of a formed tablet. In addition, the present invention provides a miniature tablet formed by the process of the present invention. The miniature tablet can be used in place of extruded beads or coated non-pareils to provide drug delivery from a capsule. The present invention also provides more consistency in drug content than that provided by non-pareil beads. The present invention provides an economical method of making miniature tablets without using complex extrusion and spheronization processes.

The invention will be more fully described by reference to the following drawings.

### BRIEF DESCRIPTION OF THE DRAWINGS

FIG. 1 is a perspective view of a tablet press apparatus in accordance with the teachings of the present invention.

FIG. 2 illustrates the miniature tablet of the present invention in comparison to a conventional tablet.

FIG. 3 is a schematic diagram of areas of the tablet press used in combination with a lower punch during a tablet press cycle.

FIG. 4 illustrates the tablet press apparatus.

FIG. 5 illustrates a paddle control mechanism.

FIG. 6A is a schematic diagram of a fill cam in combination with a lower punch.

FIG. 6B is a schematic diagram of a fill cam in combination with a reinforced portion of the lower punch and a counterbore of a die in which the punch stem is in the counterbore.

FIG. 6C is a schematic diagram of a fill cam in combination with a reinforced portion of the lower punch and a counterbore of a die in which the punch stem is in the bore of the die.

FIG. 6D is a perspective view of a fill cam having an aperture positioned at a bottom edge of the fill cam.

FIG. 6E is a perspective view of a fill cam having an aperture positioned at a distance above the bottom edge.

FIG. 7 illustrates an upper cam in combination with an upper punch.

FIG. 8 illustrates a weight cam.

FIG. 9 illustrates a scraper bar.

FIG. 10 is a perspective view of a pull down cam.

FIG. 11A is a schematic view of a compression ramp and control mechanism.

FIG. 11B is a top plan view of the compression ramp and control mechanism.

FIG. 12A is a schematic diagram of adjustable ramp during compression between an upper die and a lower die.

FIG. 12B is a schematic diagram of adjustable ramp during compression between an upper die and a lower die.

FIG. 12C is a schematic diagram of adjustable ramp during compression between an upper die and a lower die.

FIG. 13 is a schematic diagram of a prior art compression wheel.

FIG. 14 illustrates a headroom plate and transducer.

FIG. 15 is a schematic diagram of a mechanical strength testing apparatus.

FIG. 16 is a perspective view of an alternate embodiment in accordance with the teachings of the present invention.

FIG. 17 is a schematic diagram of areas of the tablet press used in combination with a lower punch during a tablet press cycle.

FIG. 18 is a schematic diagram of a lower punch used in the press of claim 16.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

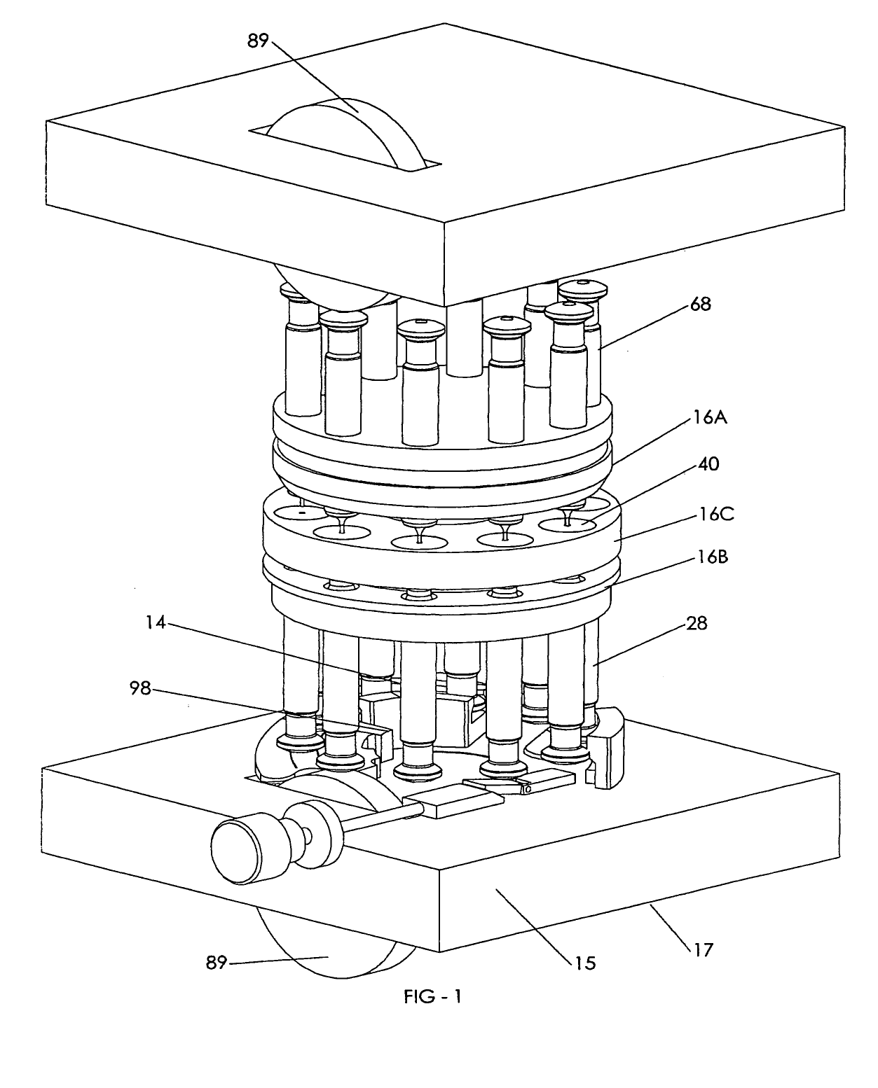

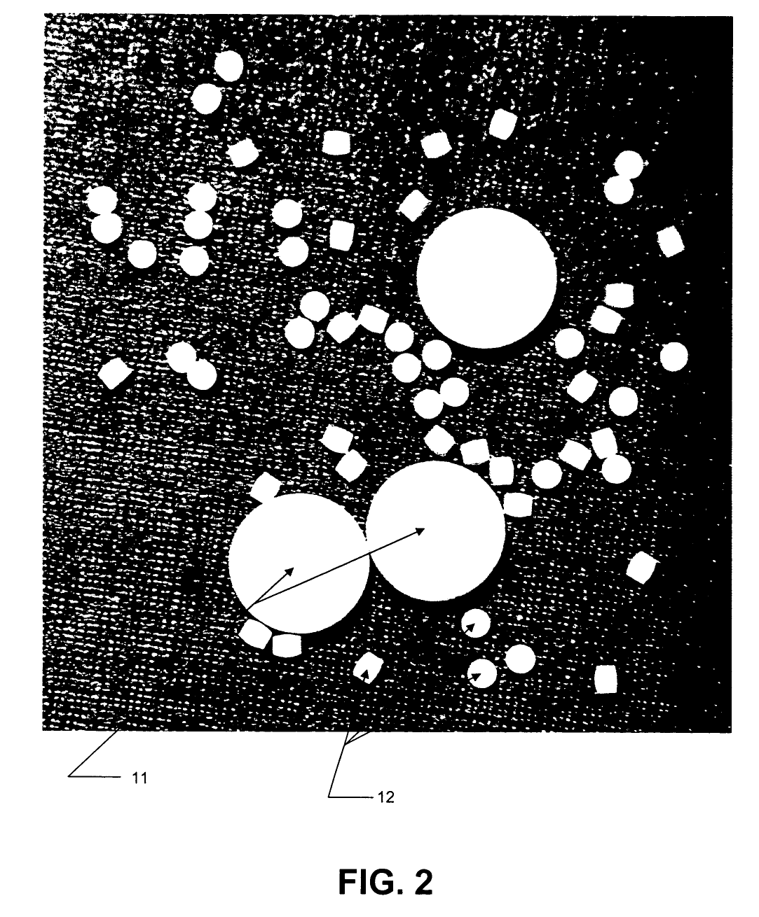

FIG. 1 illustrates a perspective view of tablet press apparatus 10 in accordance with the teachings of the present invention. Tablet press apparatus 10 is used to form miniature tablets 12, as shown in FIG. 2. Miniature tablets 12 have a size and shape that is chosen as desired. Miniature tablets 12 have a substantially spherical shape. Miniature tablets 12 have a size in the range of about 0.5 mm to about 5.0 mm in diameter with preferred sizes of about 1.0 mm, about 1.5 mm and about 2.0 mm in diameter. The weight of miniature tablet 12 depends upon its components and size. A 2 mm diameter miniature tablet 12 typically weighs about 3 to about 10 milligrams (mg). Miniature tablets 12 can be formed having the following shapes ball, round, oval, capsule and square, all with different complexities, such as shallow, standard and deep. Any tablet geometry traditionally used in larger sized tablets can be fabricated in accordance with the teachings of the present invention. Conventional tablets 11 typically have a diameter of about 10 mm or greater.

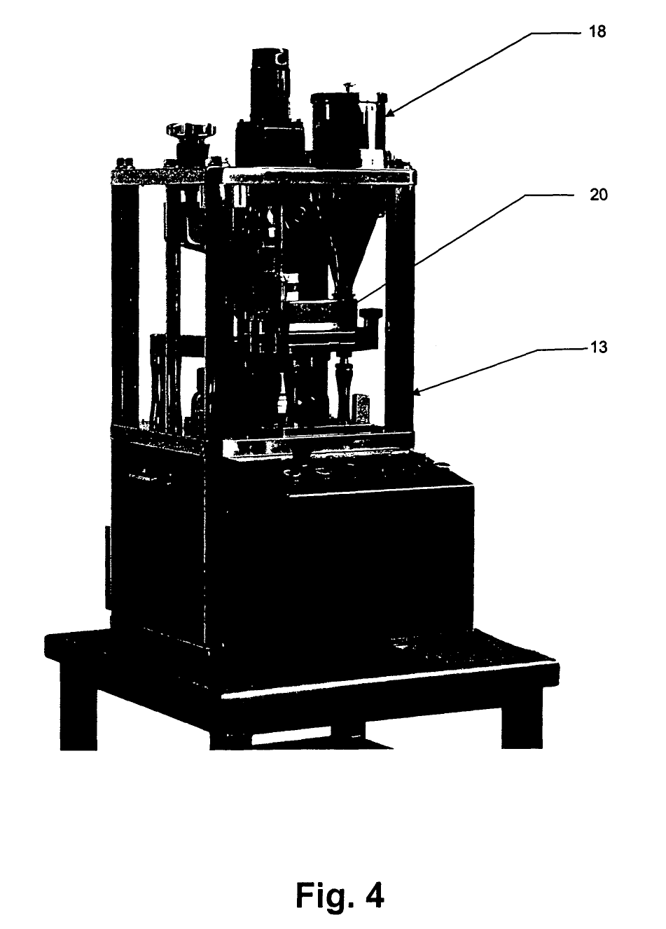

Referring to FIGS. 1 and 4, tablet press apparatus 10 of the present invention comprises a modified Riva Piccola 10-station tablet press. Tablet press apparatus 10 includes frame 13 for mounting various components. Turret 16 rotatable by an electrically powered drive mechanism 17 is mounted underneath support plate 15. In this embodiment of the invention turret 16 includes upper turret portion 16a having openings extending vertically therethrough which receive upper punches 68, lower turret portion 16b having openings extending vertically therethrough which receive lower punches 28 and central turret portion 16c into which dies 40 are mounted. Openings in upper turret portion 16a are aligned with corresponding openings in lower turret portion 16b and corresponding dies of central turret portion 16c. Turret 16 is provided with a number of possible stations, for example 10 stations and a predetermined number of stations can be in use.

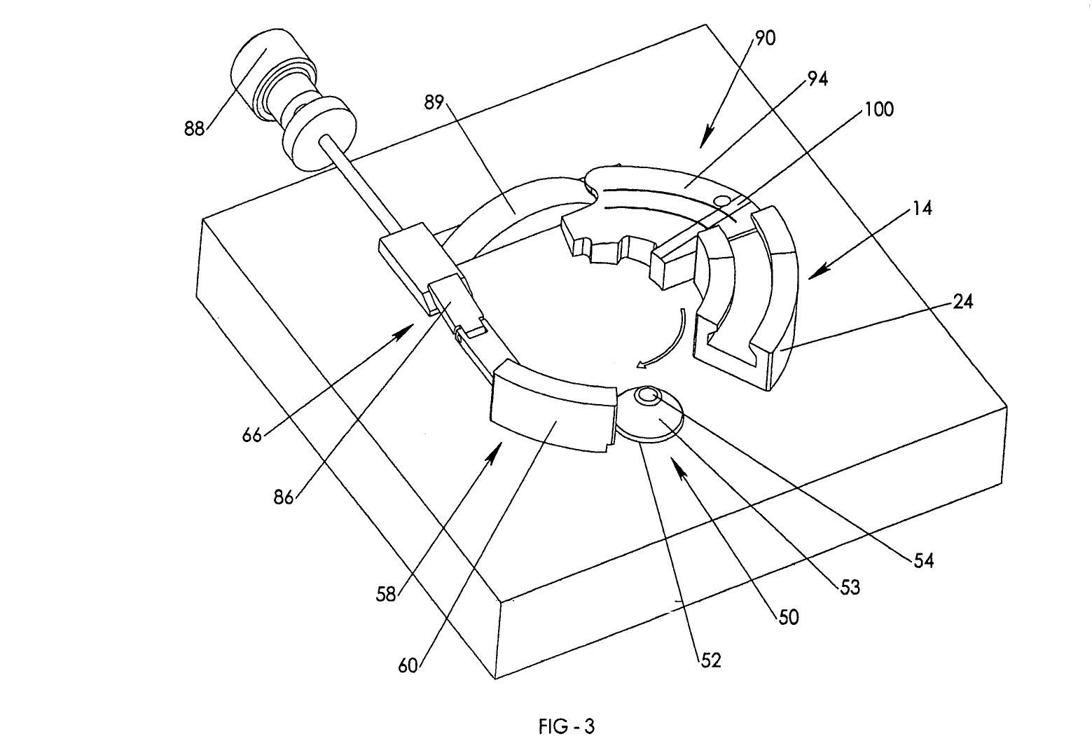

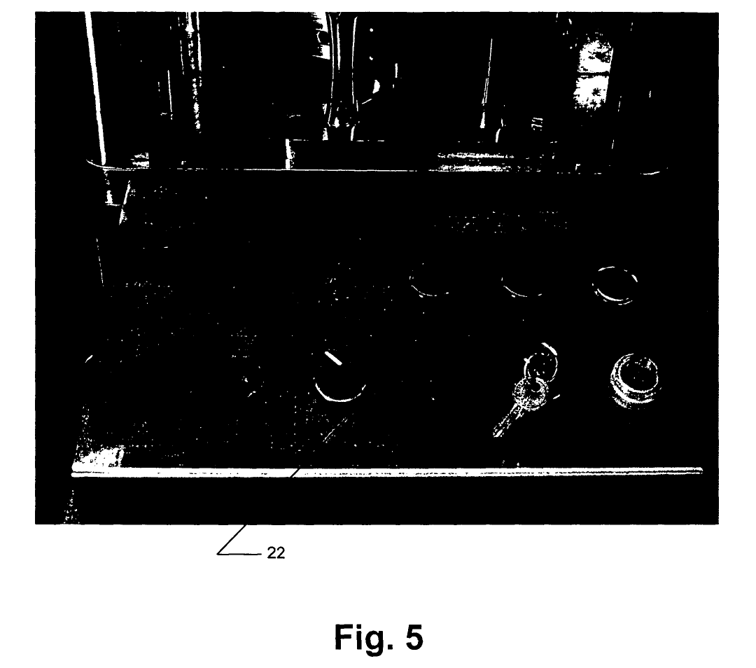

Referring to FIGS. 3A, 3B and 4, tablet fill area 14 is used for filling a die with an amount of tablet mixture from which miniature tablets 12 are made. Hopper 18 feeds the tablet mixture to paddle feeder 20 which distributes the tablet mixture uniformly and evenly into die 40. Control module for paddle feeder 22 is provided in the present invention for controlling paddle speeds used in a conventional Riva Piccola press, as shown in FIG. 5. It has been found that typical paddle speeds of up to 60 RPM used in the conventional Riva Piccola press for producing tablets having a size of about 10 mm and weights in the range of 350 mg to 500 mg do not provide proper fill for producing tablets having weights of less than about 10 mg. Control module for paddle feeder 22 reduces the paddle speeds used in the conventional Riva Piccola press by a factor of 6 in order to optimize feed into dies 40. Control module for paddle feeder 22 can comprise electronics coupled to paddle feeder 20.

Referring to FIGS. 1, 3 and 6, as each station moves into tablet fill area 14, fill cam 24 is used to fill die 40 by a pre-determined amount of the tablet mixture by placement of fill cam 24 to create sufficient tablet mixture fill depth within bore 44 of die 40. Bore 44 is sized to have a diameter corresponding to the diameter of miniature tablet 16. Die 40 is typically filled with an amount greater than the amount needed in the formed miniature tablet 12. For example, about 7 mg to about 8 mg are filled into die 40 in tablet fill area 14 to form a tablet having a desired weight of about 5 mg.

Fill cam 24 includes aperture 26 for receiving punch head 32 of lower punch 28. Lower punch has a cylindrical body portion connecting punch stem 38 positioned at upper portion 34 of lower punch 28 to punch head 32 positioned at lower portion 30 for engagement with fill cam 24 and various other cams of tablet press apparatus 10. Punch stem 38 is sized to have a diameter to fit snugly in bore 44. Punch stem 38 has a length such that punch stem 38 can be received in bore 44 during tablet making and a portion, punch tip 39, can extend through the length of bore 44 to outside of die 40 for ejecting a formed tablet from bore 44. For example, punch stem 38 can have a diameter slightly smaller than a size of bore 44 for each size of miniature tablet 16, such as about 0.025 mm to about 0.0375 mm less than the diameter of bore 44 which can be in the range of about 1.0875 mm to about 2.0125 mm for a 2.0 mm tablet. In an embodiment of the present invention, end of punch tip 39 is concave to impart a convex shape to a lower side of miniature tablets 12.

As each station enters tablet fill area 14, fill cam 24 engages punch head 32 of lower punch 28 associated with the station moving through tablet fill area 14 and directs lower punch 28 downwardly as it passes through tablet fill area 14, resulting in punch stem 38 being pulled downwardly in bore 44 of die 40 a pre-determined amount as set by placement of fill cam 24 to create sufficient fill depth inside bore 44. In addition to gravity, the mixture for forming the miniature tablets flows into bore 44 of die 40 due to a suction effect created as punch stem 38, which fits snugly in bore 44, moves downwardly within bore 44.

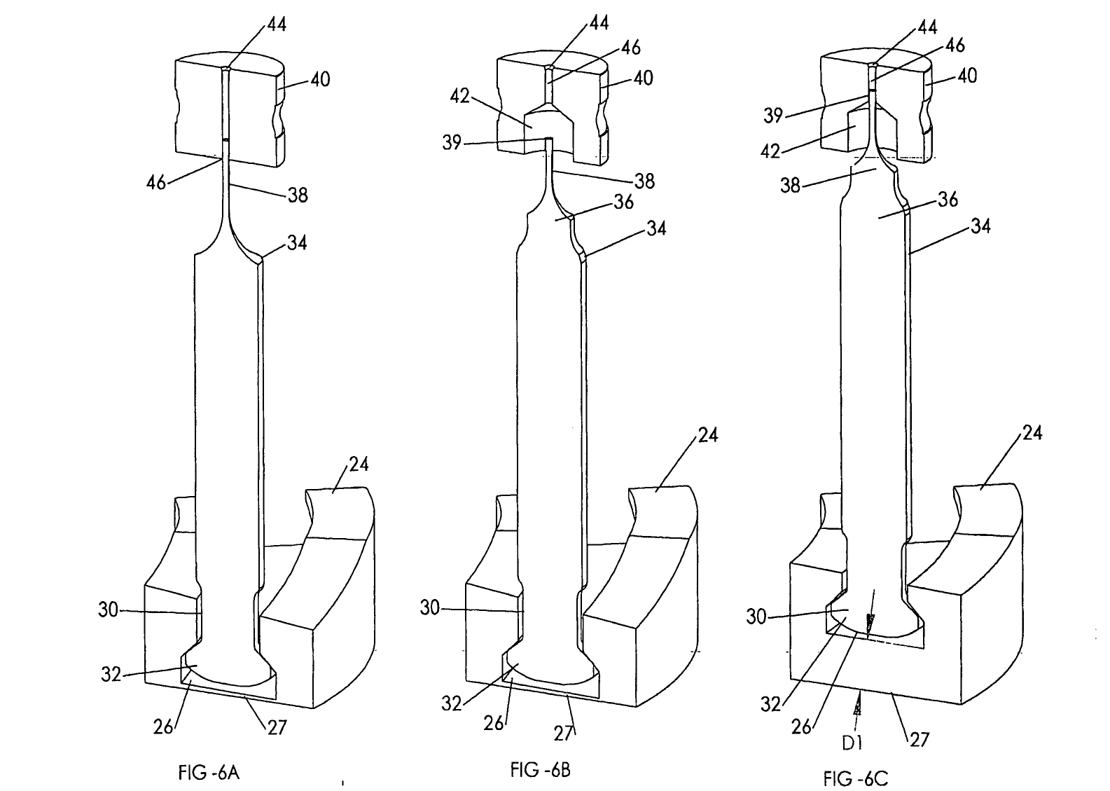

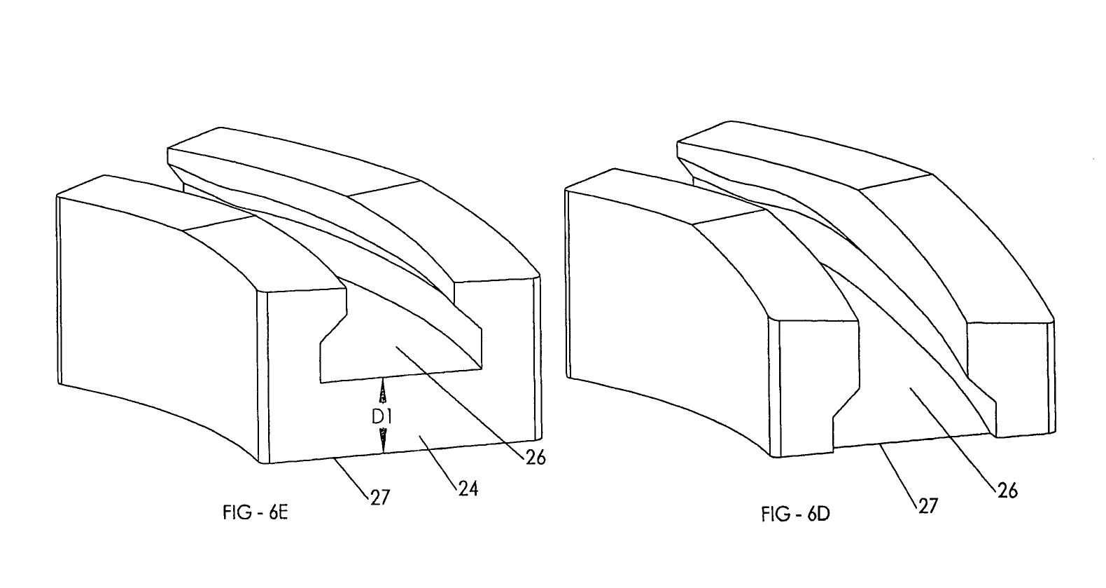

It has been found that a punch stem 38 having a diameter of less than about 2.0 mm, as shown in FIG. 6A, can be prone to breakage during compression forces used in a conventional tablet press. In an embodiment of the present invention, lower punch 28 includes reinforced body portion 36 at upper end 34 of lower punch 28, as shown in FIGS. 6B and 6C. Reinforced body portion 36 is received in counterbore portion 42 of die 40 to reduce the length to diameter ratio and reduce a column effect created by the use of a long slender design for punch stem 28.

Conventional fill cam 24 of the Riva Piccola tablet press, as shown in FIG. 6A, includes aperture 26 positioned at bottom edge 27 to withdraw fill cam all the way down and position punch stem 38 in lower portion 46 of bore 44, as shown in FIG. 6C. It has been found that if conventional fill cam 24 is used with counterbore portion of die 40, punch stem 38 does not extend into lower portion 46 of bore 44 of die 40, as shown in FIG. 6B, thereby allowing the mixture for forming the tablet to escape. In an embodiment of the present invention, fill cam 24 was modified to position aperture 26 at a distance D1 from bottom edge 27 of fill cam 24 in order to position reinforced body portion 36 always within counterbore portion 42 and at least a portion of punch stem 38 is always within lower portion 46 of bore 44, as shown in FIGS. 6C and 6E. Accordingly, in this embodiment because punch stem 38 is never completely withdrawn from lower portion 46 of bore 44 the mixture for forming the miniature tablets is retained in bore 44 by punch stem 38 and is prevented from flowing into counterbore portion 42 from bore 44.

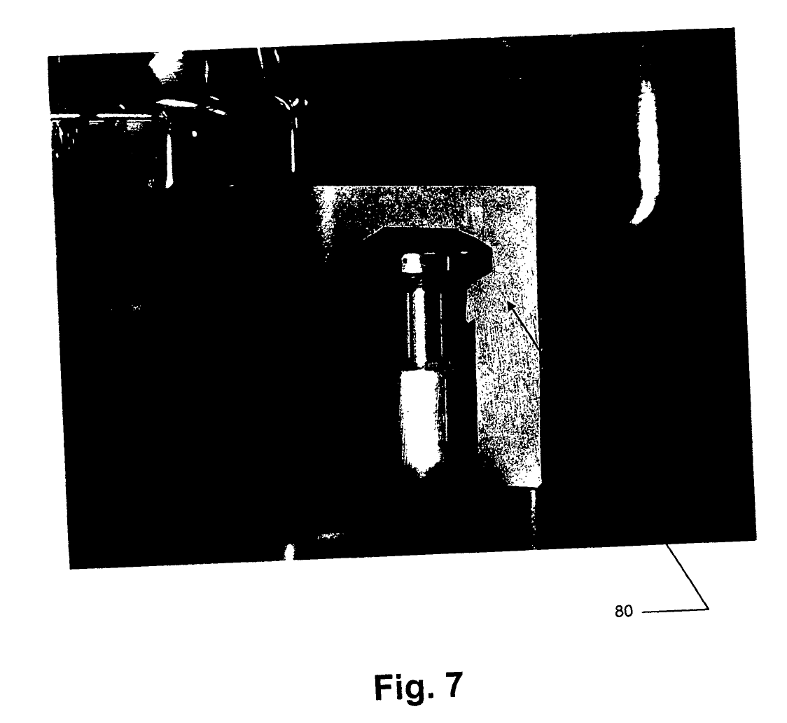

Referring to FIG. 7, in tablet fill area 14 the positioning of upper punch 68 is directed by upper cam 89 for positioning upper punch 68 above and out of die 40.

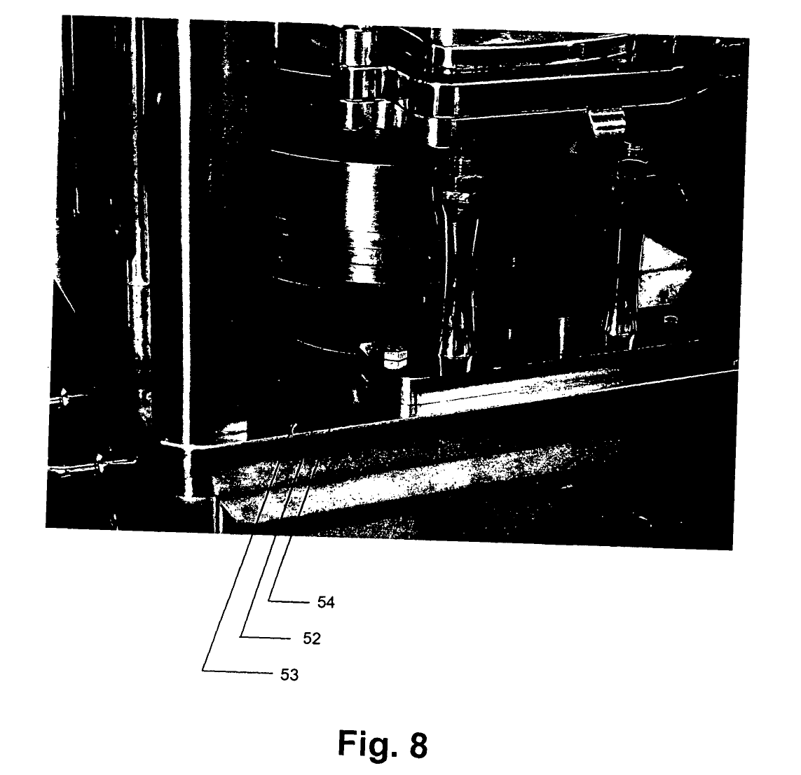

Referring to FIG. 3, upon exiting tablet fill area 14, the station enters weight adjustment area 50 where the amount of the mixture for forming the tablet in bore 44 of die 40 is adjusted to correspond to the weight desired for miniature tablet 12. Weight adjustment area 50 includes weight cam 52, as shown in FIG. 8. Weight cam 52 comprises a cylindrical body portion 53 and a domed top 54. The height of weight cam 52 is adjustable and the height selected for weight cam 52 determines how far lower punch 28 is pushed upwardly when punch head 32 of lower punch 28 hits weight cam 52. The height of weight cam 52 is selected such that punch stem 38 of lower punch 28 moves upwardly in bore 44 of die 40 to push out of die 40 the excess amount of the mixture where the upper punch enters for forming the miniature tablet. For example, for forming a miniature tablet 16 of 5 mg, the overfill amount of 2 mg to 3 mg of the filled amount of 7 mg to 8 mg is pushed out of bore 44 of die 40 leaving the desired 5 mg in bore 44 of die 40. Filling die 40 with more tablet mixture than is needed and then subsequently pushing out the excess amount before miniature tablet 12 is formed provides a more consistent weight of miniature tablet 12.

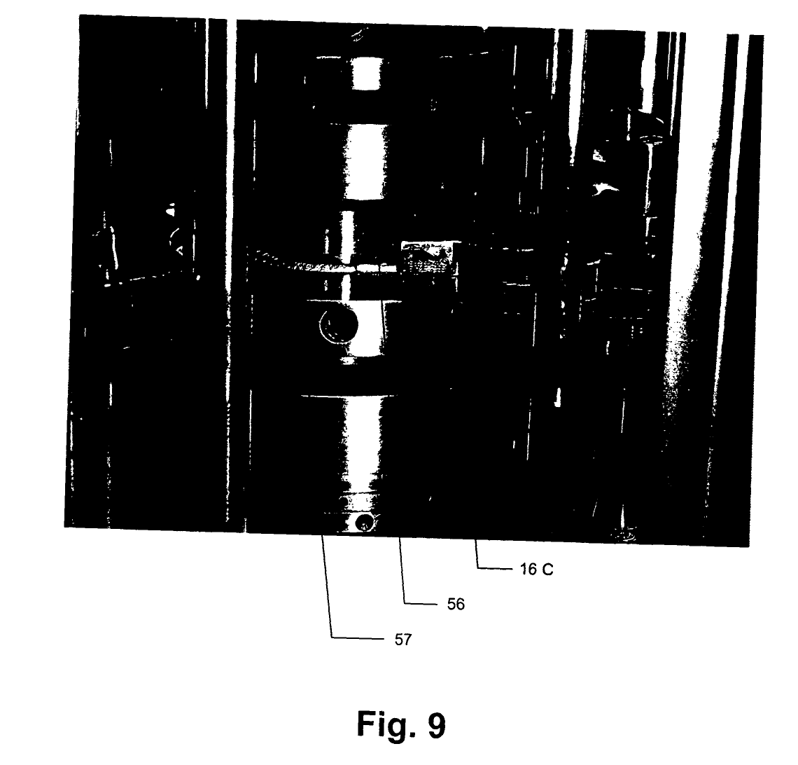

Referring to FIG. 9, scraper bar 56 is positioned flush with the upper surface of central turret portion 16c and scrapes of excess tablet mixture which has been pushed out of die 40 caused by lower punch 28 engaging weight cam 52. The excess tablet mixture scraped off by scraper bar 56 is directed by scraper bar 56 to trowel 57 for collection and re-use.

While the station is in weight adjustment area 50, upper punch 68 is directed by cams to remain spaced above and out of die 40, as shown in FIG. 3.

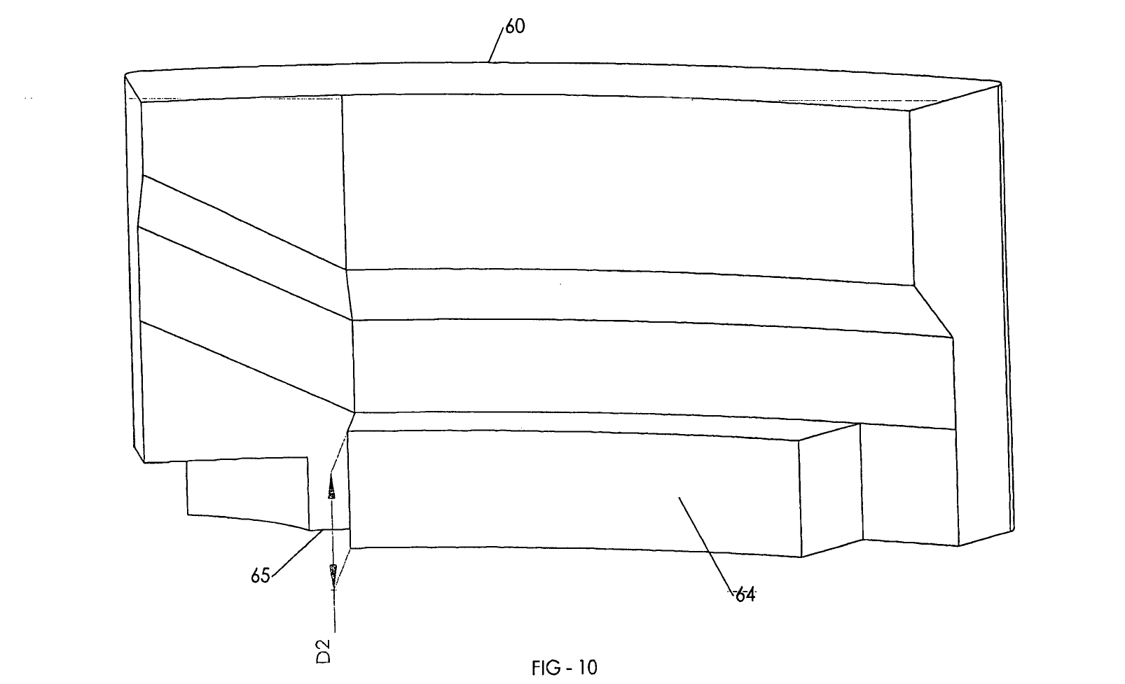

Referring to FIG. 3, upon exiting weight adjustment area 50, the station enters pull down area 58. In pull down area 58, pull down cam 60 directs lower punch 28 downwardly along pull down area 62 for moving lower punch downwardly in die 40, as shown in FIG. 10. The mixture for forming the miniature tablet, is pulled down in bore 44 of die 40 by suction created by lower punch 28 moving downwardly in die 40 to prevent puffing of the mixture when the upper punch enters for forming the miniature tablet. Portion 64 of pull down cam 60 is positioned at a distance D2 from edge 65 of pull down cam 60 to limit the amount travel of pull down cam 60 in order to retain punch stem 38 within bore 44 of die 40, thereby preventing the mixture for forming the miniature tablet from entering counterbore 42 of die 40.

While the station is in pull down area 58, upper punch 68 is directed by cams to remain spaced above and out of die 40, as shown in FIG. 3.

Referring to FIG. 3, upon exiting pull down area 58, the station enters tablet compression area 66 where the mixture for forming the miniature tablet is compressed into miniature tablet 12. Tablet compression area 66 can comprise pre-compression area of a standard Riva Piccola press which has been modified in accordance with the present invention. It has been found that a force in the range of about 50 to about 2000 Newtons (N) used in compression area 66 is sufficient to form miniature tablet 12. For example, a typical compression force for producing a 2 mm diameter miniature tablet 16 is about 200 Newtons.

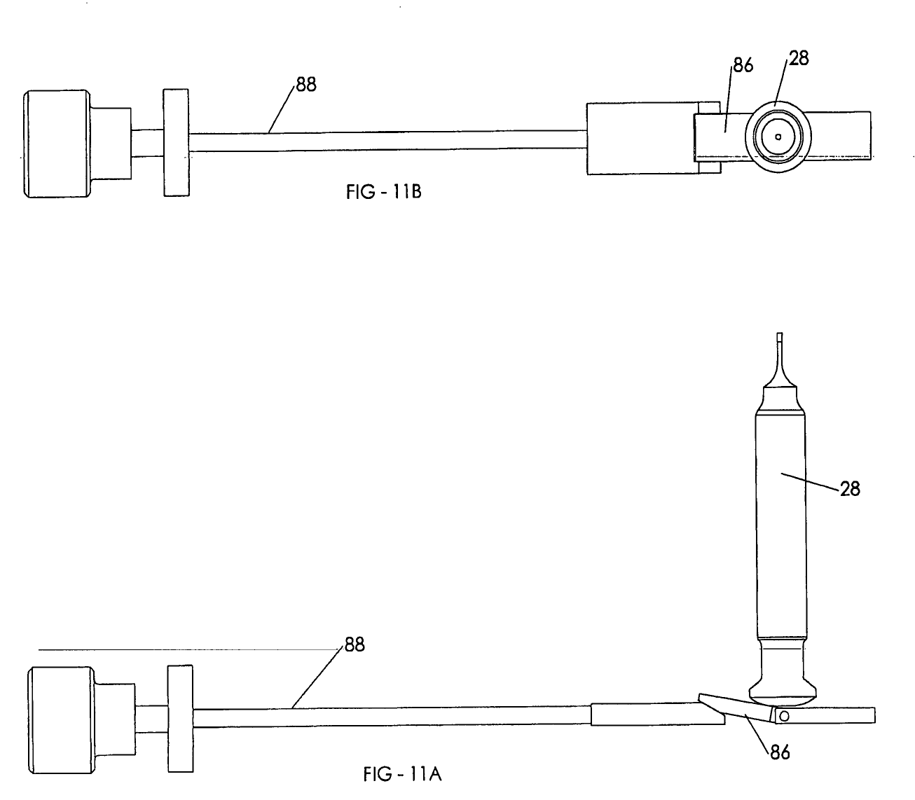

In tablet compression area 66, adjustable ramp 86 directs upper punch upwardly when punch head 32 of lower punch 28 engages the ramp, as shown in FIGS. 11A-11B. The height of adjustable ramp 86 is adjustable to a selected height using height control mechanism 88. The amount of compression force provided by lower punch is determined by the height set for adjustable ramp 86. Raising the height of adjustable ramp 86 causes lower punch 28 to move upwardly farther into die 40 as lower punch 28 rides up adjustable ramp 86, thereby increasing the amount of compression force provided by lower punch 28. Lowering the height of adjustable ramp decreases upward movement of lower punch 28 as lower punch 28 rides up adjustable ramp 86, thereby decreasing the amount of compression force provided by lower punch 28. Height control of adjustable ramp 86 by height control mechanism 88 provides precise control of compression force settings for forming miniature tablets 12 of the present invention.

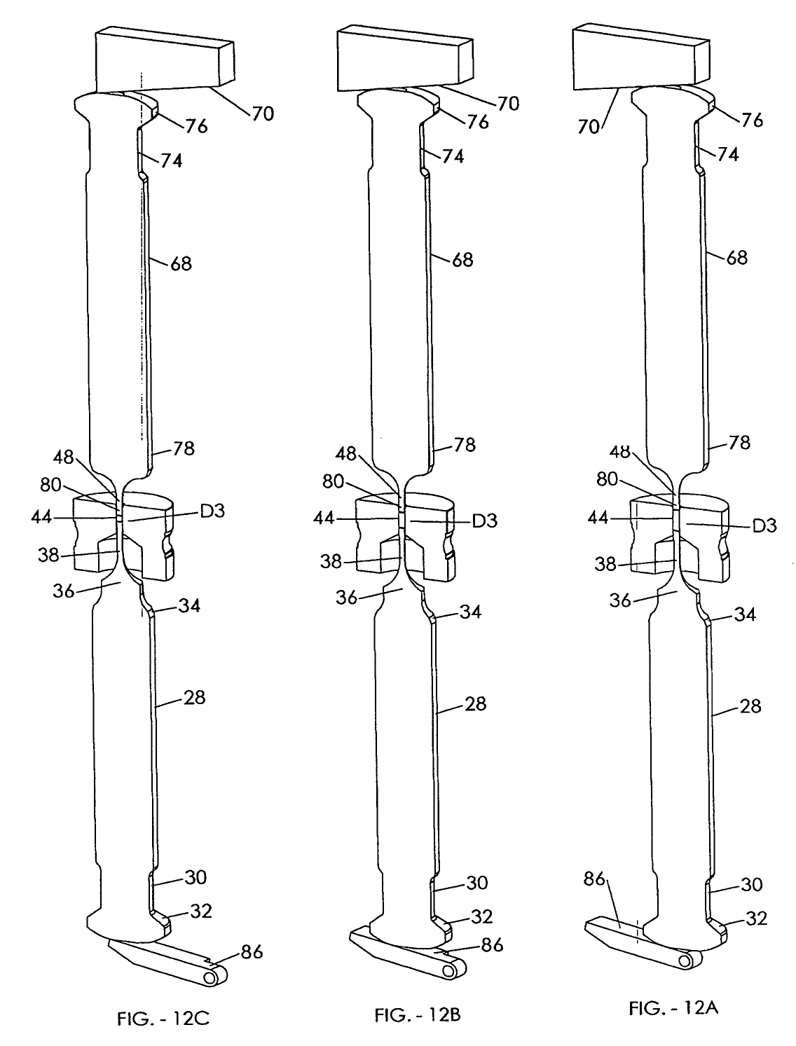

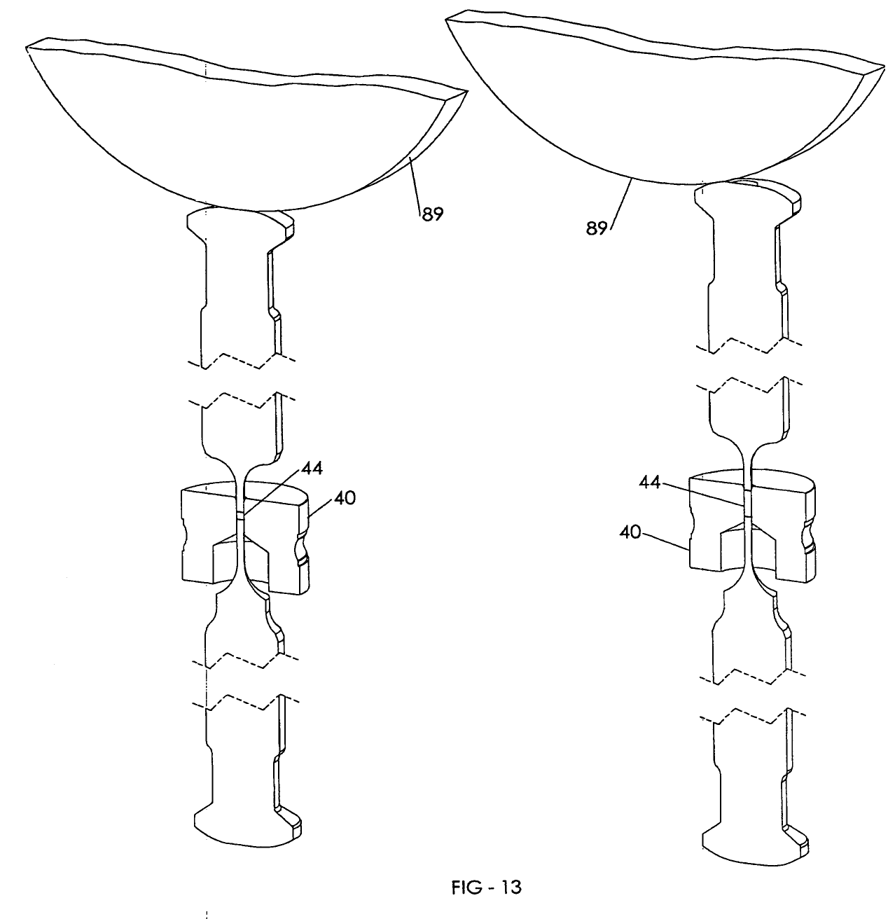

In tablet compression area 66, upper punch 68 is directed by upper cam 70 downwardly into die 40 as lower cam 26 is directed by adjustable ramp 86 into die 40, as shown in FIGS. 12A-12C. Upper punch 68 comprises punch stem 80 positioned at lower end 78 of upper punch 68. Punch stem 80 has a diameter which matches the diameter of punch stem 38 of lower punch 26. Punch tip 82 at the end of punch stem 80 can have a cylindrical body portion to impart a convex shape to the upper side of the miniature tablets. Punch head 76 is positioned at upper end 74 of upper punch 68. Lower portion has a cylindrical body for connecting punch stem 80 to punch head 76. Punch head 76 can have a knob shape for engaging upper cam 70 and various other cams of tablet press apparatus 10.

In tablet compression area 66, punch head 32 of lower punch 26 moves upwardly along adjustable ramp 86 as punch head 76 of upper punch 68 moves downwardly along upper cam 70 for decreasing the distance D3 between punch stem 38 of lower punch 26 and punch stem 80 of upper punch, as shown in the progression of FIG. 12A to FIG. 12B. Additional movement of lower punch upwardly along adjustable ramp as punch head 76 of upper punch 68 moves downwardly along upper cam 70 further decreases the distance D3 between punch stem 38 of lower punch 26 and punch stem 80 of upper punch to provide the desired compaction, as shown in the progression of FIG. 12B to FIG. 12C. In the present invention, compression rollers 89 used in the prior art conventional Riva Piccola press shown in FIGS. 1 and 13 are disabled and all compression is performed in tablet compression area 66.

Referring to FIGS. 1 and 3, the punch set of lower punch 26 and upper punch 68 enters tablet ejection area 90 for ejecting a formed miniature tablet 12 from die 40. Lower punch 26 ejects formed miniature tablet from die 40 by lower ejection cam 94 extending punch stem 38 through the entire length of bore 44 as upper ejection cam 96 raises upper punch 68. Miniature tablet 12 is removed from punch tip 39 of lower punch 26 by take-off plate 98 knocking off miniature tablet 12 from punch tip 39 of lower punch 26 as lower punch passes under take-off plate 98 without hitting take-off plate 98 in tablet take-off area 98. As take-off plate 98 knocks the formed tablets off of each punch tip 39 of lower punches as successive stations pass by it, miniature tablets 12 are gradually forced to the beginning of take-off chute 100 and then fall down take-off chute 100 into collection bin 104.

Referring to FIG. 3, upper punch 26 and lower punch 68 are directed into tablet fill area 14 to repeat another revolution through tablet fill area 14, weight adjustment area 50, pull down area 58, tablet compression area 66, ejection area 92 and tablet take-off area 98 to produce another miniature tablet.

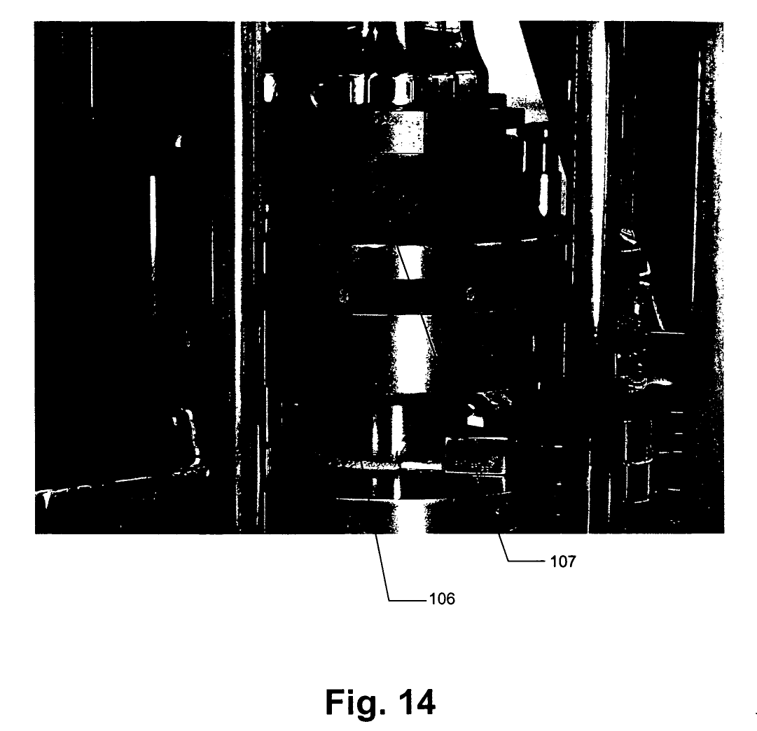

As station exits pull down area 58 and enters tablet compression area 66, head room plate 106 provides space such that punch head of upper punch 68 is not directed downwardly until it engages ramp of upper cam 70 when compression is used to form miniature tablet 16, as shown in FIG. 14. Transducer 107 measures compression forces of upper punch 68 such that compression forces can be precisely controlled.

Transducers may be provided at various locations, such as compression, ejection cam 94 and take-off plate 99 to measure and monitor forces exerted at these locations. A computer (and monitoring software) can receive signals corresponding to forces registered by transducers 107 to ensure proper functioning of tablet press apparatus 12 to form inventive miniature tablet 12. Tablet press apparatus 12 is provided with control mechanisms for starting and stopping tablet press apparatus 12 and setting the speed of rotation of turret 16. A transducer may be connected to drive mechanism 17 connected to turret 16 to detect turret speed. Tablet press apparatus 10 can be operated at a speed to meet the requirements of production and tablet mixture. For example, tablet press apparatus can be operated at about 100 rotations per minute of turret 16.

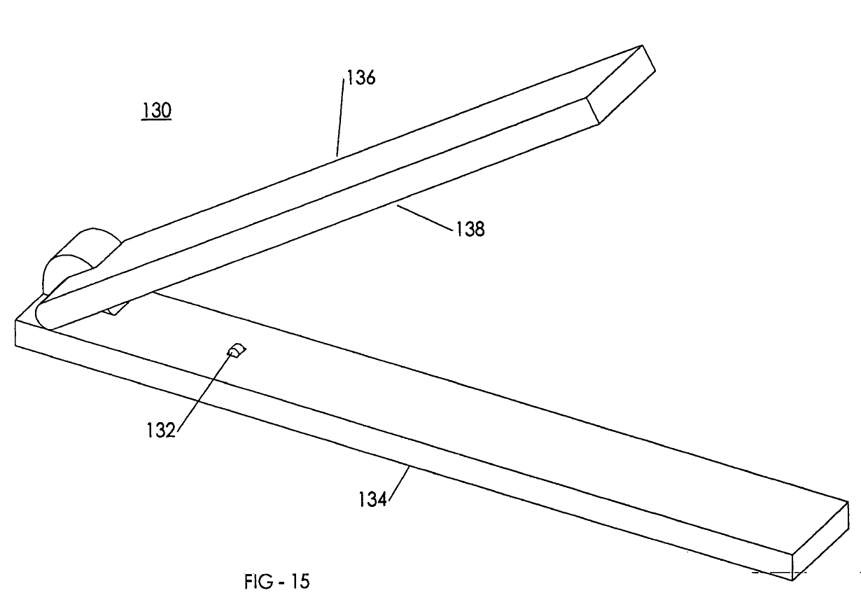

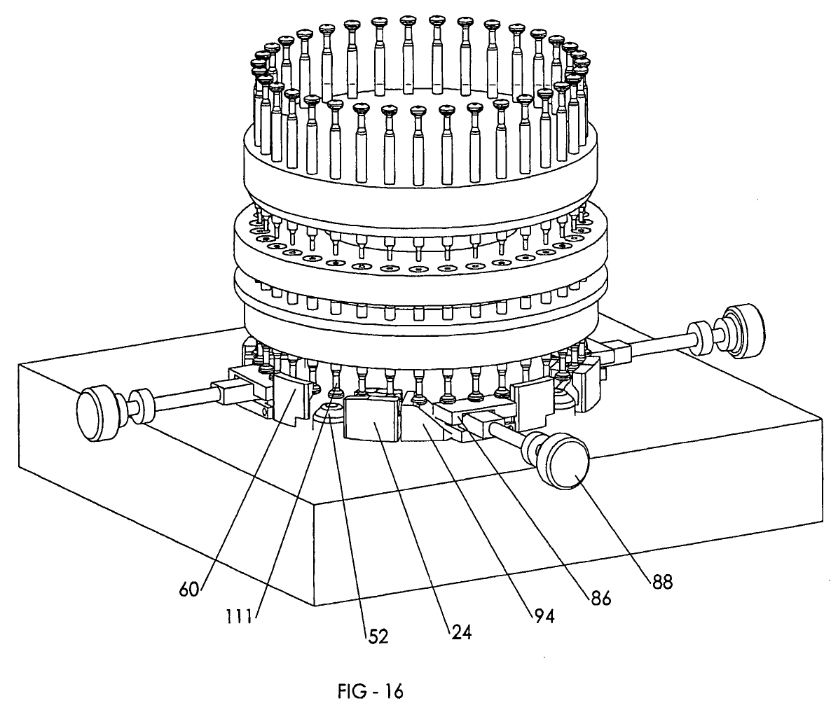

Referring to FIG. 15, tablet mechanical strength testing apparatus 130 can be used to test mechanical strength of formed miniature tablet 12. Apparatus includes aperture 132 which has received miniature tablet 12 in base arm 134 for receiving miniature tablet 12.

Moveable press arm 136 is pressed downwardly or rolled over miniature tablet 12 received in aperture 132 of base arm 134. Load cell 138 monitors force applied by press arm 136 to break miniature tablet 12.

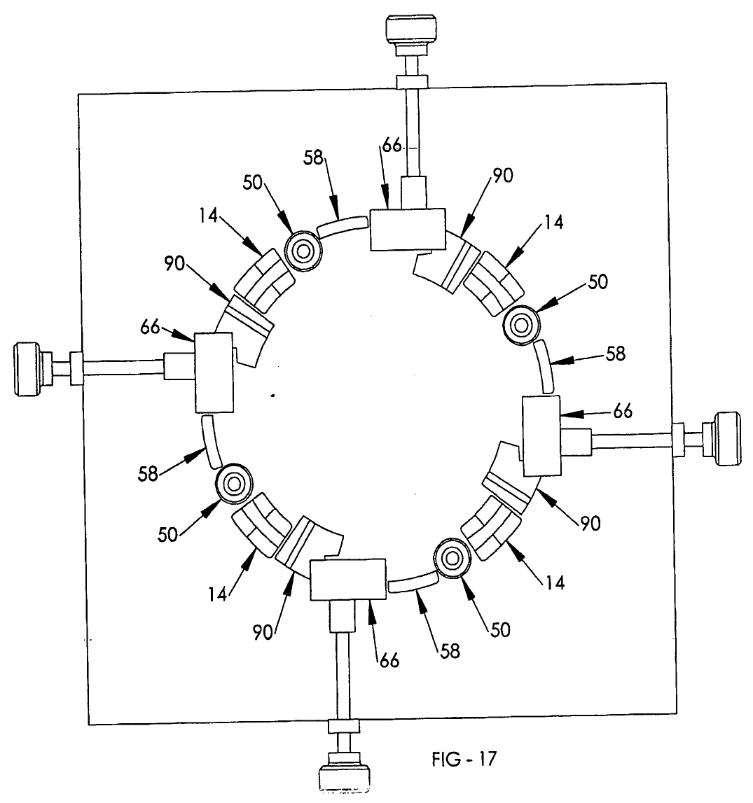

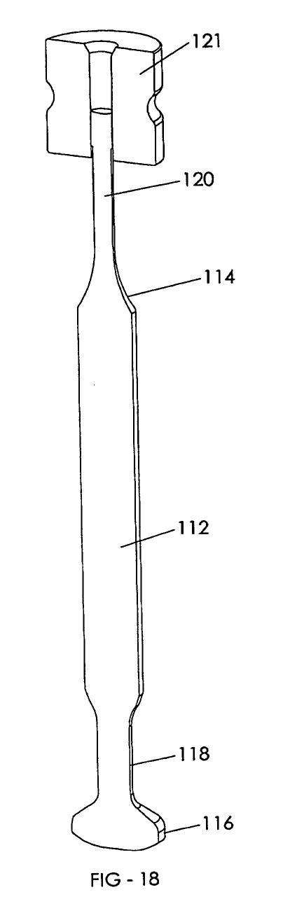

In an alternate embodiment illustrated in FIGS. 16-18, tablet press apparatus 110 includes lower punch 111 with modified body portion 112 to have a reduced diameter in comparison with the body portion of lower punch 26. For example, body portion 112 of lower punch 111 can have a diameter of about 5 mm to about 7 mm which is significantly reduced for the diameter of about 19 mm to about 25 mm of lower punch 26. Die 121 can have a reduced height in comparison to die 40. The reduced diameter of body portion 112 and the die height is used to reduce the column effect of forces on punch stem 120 positioned at upper end 114 of lower punch 111. Punch stem 120 can have similar dimensions as punch stem 38 of lower punch 26, described above. Punch head 116 positioned at lower end 118 of lower punch 111 has a reduced diameter in comparison with punch head 32 of lower punch 26. For example, punch head 116 can have a similar diameter as body portion 112 of lower punch 111, as described above. Similar dimensions of the diameter of an upper punch can be used. For example, die 121 can have a height of about 10 mm in comparison to a height of 22 mm of die 40. The reduction in size of the lower punch and upper punch allows more stations to be provided on turret 16 with a plurality of tablet fill area 14, weight adjustment area 50, pull down area 58, tablet compression area 66, ejection area 92 and tablet take-off area 98, as shown in FIG. 17. For example, up to 35 stations can be used on a four-sided press in this embodiment to provide 840,000 tabs/min at 100 RPM revelation in comparison to 10 stations used in the conventional Riva Piccola press to provide 60,000 tabs/min. Because of reduced forces used for compression of miniature tablets 16, frame 13 can be formed of a lighter weight material and smaller motor, such as a direct current motor can be used for powering tablet press apparatus 100.

In accordance with the invention, conventional excipients and lubricants may be used in the tablet mixture, in addition to any desired drug to be incorporated into the miniature tablets. Typical or representative excipients and lubricants in the tablet mixture are as follows:

| Excipient | % by weight (typical range) |
|---|---|
| MCC | 0-60% |
| Free-flow or Fast-flow lactose | 0-60% |
| Starch | 0-20% |
| Magnesium Stearate | 0-5% |
| Stearic Acid | 0-5% |
| Talc | 0-5% |
| Hydrophilic Polymers | 0-95% |

In accordance with the invention, hydrophilic polymers may be used in the tablet mixture to form the inventive miniature tablets 11, and exemplary of these polymers are those that interfere with the wet extrusion of the wet mass, e.g., cellulosic polymers, including hydroxypropyl cellulose (HPC) and hydroxypropyl methylcellulose (HPMC), gums, including xanthan gum, gum karaya, guar gum and locust gum, carrageenan, partially and fully pre-gellatized starches, gelatins, PVAP, acrylic acid based polymers, and mid-to-high levels of polyvinylporrolidone of different molecular weights, and sodium carboxymethylcellulose (NaCMC) (Cekol).

Preferably, the tablet mixture is micronized to facilitate flow of the tablet mixture into the tablet die, which is discussed in more detail below.

Typical of the drugs that may be incorporated into the tablet mixture to be formed into the inventive miniature tablets are the same drugs that may be incorporated into larger tablets, such as 350 mg tablets, 500 mg tablets, or higher. Further, the drugs include those that are being considered for layering onto non-pareils or are being considered for wet granulation/extrusion and spheronization.

Advantages

The invention has many advantages, which include:

1) providing miniature tablets 12;

2) providing a miniature drug delivery device that contains a uniform amount of drug and has a uniform weight;

3) providing a drug delivery device having a size similar to non-pareils without the problem of drug content consistency sometimes found with non-pareils;

4) providing miniature tablets 12 containing hydrophilic polymers;

5) providing an inventive method that permits precise control in setting and monitoring compression forces; and

6) providing an effective, efficient, and economic method of producing miniature tablets 12.

It is to be understood that the above-described embodiments are illustrative of only a few of the many possible specific embodiments which can represent applications of the principles of the invention. Numerous and varied other arrangements can be readily devised in accordance with these principles by those skilled in the art without departing from the spirit and scope of the invention.

What is claimed is:

1. An apparatus for forming miniature tablets comprising:
a die having a bore therethrough, said bore having a diameter of less than about 3 mm;
a lower punch having a diameter of a punch stem slightly smaller than said bore for allowing said lower punch to fit snugly in said bore;
an upper punch having a diameter of a punch stem substantially the same as the diameter of the lower punch; and
a means for providing a predetermined amount of compression force between said lower punch and said upper punch, wherein said compression force is in a range of about 50 Newtons to about 2,000 Newtons.

2. The apparatus of claim 1 wherein said compression force is in a range of about 50 Newtons to about 500 Newtons.

3. The apparatus of claim 1 wherein said means for providing a predetermined amount of compression force comprises an adjustable ramp and means for controlling the height of said ramp, wherein said lower punch rides up said adjustable ramp for providing the compression force.

4. The apparatus of claim 3 further comprising an upper cam including a ramp, wherein said upper punch rides down said ramp of said upper cam for providing the compression force.

5. The apparatus of claim 1 wherein said punch stem of said lower punch comprises a reinforced body portion at an upper end of said lower punch and said die comprises a counterbore positioned below said bore, said counterbore receiving said reinforced portion of said lower punch during application of said compression force.

6. The apparatus of claim 5 further comprising a fill cam for pulling down said lower punch during filling of said die, said fill cam comprising adjusting means for pulling punch stem of lower punch downwardly a predetermined amount such that said punch stem of said lower punch is retained in said bore.

7. The apparatus of claim 6 wherein said adjusting means for said fill cam comprises an aperture positioned at a distance D₁ from a bottom edge of said fill cam.

8. The apparatus of claim 6 further comprising a pull down cam for pulling down said lower punch after filling of said bore, said pull down cam comprising adjusting means for pulling punch stem of lower punch downwardly a predetermined amount such that said punch stem of said lower punch is retained in said bore.

9. A method for forming a miniature tablet in a tablet press comprising:
a die having a bore therethrough, said bore having a diameter of less than about 3 mm, a lower punch having a diameter of a punch stem slightly smaller than said bore for allowing said lower punch to fit snugly in said bore, an upper punch having a diameter of a punch stem substantially the same as the diameter of the lower punch comprising the step of:
providing a predetermined amount of compression force between said lower punch and said upper punch, wherein said compression force is in a range of about 50 Newtons to about 2,000 Newtons.

10. The method of claim 9 wherein said compression force is in a range of about 50 Newtons to about 500 Newtons.

11. The method of claim 9 wherein said step of providing a predetermined amount of compression force comprises an adjustable ramp and means for controlling the height of said ramp, wherein said lower punch rides up said adjustable ramp for providing the compression force and an upper cam including a ramp, wherein said upper punch rides down said ramp of said upper cam for providing the compression force.

12. The method of claim 1 further comprising the step of:
providing said punch stem with a reinforced body portion at an upper end of said lower punch and said die comprises a counterbore positioned below said bore, said counterbore receiving said reinforced portion of said lower punch during application of said compression force.

13. The method of claim 12 further comprising providing a fill cam for pulling down said lower punch during filling of said die, said fill cam comprising adjusting means for pulling punch stem of lower punch downwardly a predetermined amount such that said punch stem of said lower punch is retained in said bore.

14. The method of claim 12 wherein said adjusting step comprises adjusting means for said fill cam comprises an aperture positioned at a distance D₁ from a bottom edge of said fill cam.

15. The method of claim 13 further comprising the step of providing a pull down cam for pulling down said lower punch after filling of said bore, said pull down cam comprising adjusting means for pulling punch stem of lower punch downwardly a predetermined amount such that said punch stem of said lower punch is retained in said bore.

16. A miniature tablet formed in accordance with the method of claim 9.

17. An apparatus for comprising product material into tablets, turrent means having means on its periphery for receiving dies which are to be filled with product material prior to compression, dies positioned in at least a portion of said means for receiving dies, said dies positioned between opposed punches, said opposed punches compressing the product material into tablets, the improvement comprising:
means for providing a predetermined amount of compression force between said lower punch and said upper punch, wherein said compression force is in a range of about 50 Newtons to about 2,000 Newtons.

18. A miniature tablet comprising a compressed shaped body having a size of 3 mm or less being prepared at a compression force in the range of about 50 Newtons to about 2,000 Newtons.

19. The miniature tablet of claim 18, the size being 2 mm.

20. The miniature tablet of claim 18, the size being 1.5 mm.

21. The miniature tablet of claim 18, the size being 1 mm.

22. The miniature tablet of claim 18, the size being 0.5 mm.

23. The miniature tablet of claim 19 wherein said miniature tablet comprises one or more drug actives.

24. An apparatus for forming miniature tablets comprising:
a die having a bore therethrough, said bore having a diameter of less than about 3 mm;
a lower punch having a diameter of a punch stem slightly smaller than said bore for allowing said lower punch to fit snugly in said bore;
an upper punch having a diameter of a punch stem substantially the same as the diameter of the lower punch;
a means for providing a predetermined amount of compression force between said lower punch and said upper punch, wherein said compression force is in a range of about 50 Newtons to about 2,000 Newtons; and
a plurality of cycles of tablet fill areas, weight adjustment areas, pull down areas, tablet compression areas and ejection areas.

25. The apparatus of claim 24 wherein a diameter of said upper punch and said lower punch is in the range of about 5 mm to about 7 mm.

26. An apparatus for testing strength of a miniature tablet comprising:
a base arm having an aperture thereon for receiving said tablet;
a press arm contacting said tablet; and
means for monitoring force applied by said press arm.
